(19) United States
(12) Patent Application Publication
(10) Pub. No.: US 2025/0108240 A1
(43) Pub. Date: Apr. 3, 2025

(54) ARTICLE OF PERSONAL PROTECTIVE EQUIPMENT

(71) Applicant: 3M INNOVATIVE PROPERTIES COMPANY, St. Paul, MN (US)

(72) Inventors: James F. Poch, New Richmond, WI (US); Kevin W. Eberman, St. Paul, MN (US); Douglas D. Jensen, Woodbury, MN (US)

(21) Appl. No.: 18/832,972

(22) PCT Filed: Jan. 23, 2023
(86) PCT No.: PCT/IB2023/050557

§ 371 Date: Jul. 25, 2024

Related U.S. Application Data
(60) Provisional application No. 63/303,208, filed on Jan. 26, 2022.

(51) Int. Cl. A62B 18/08; A62B 18/00; B01D 46/00; B01D 46/46; H01M 10/44; H01M 10/613; H01M 10/623; H01M 10/63; H01M 10/653; H01M 10/6563; H02J 7/00

(52) U.S. Cl. CPC A62B 18/08; A62B 18/006; B01D 46/0032; B01D 46/0047; B01D 46/009; B01D 46/46; H01M 10/44; H01M 10/613; H01M 10/623; H01M 10/63; H01M 10/653; H01M 10/6563; H02J 7/0068; H02J 7/00712; B01D 2273/30; H01M 2220/30

(57) ABSTRACT

An article of personal protective equipment (PPE) includes a battery, a charging circuit, and a controller. The battery is configured to power one or more components of the article of PPE. The charging circuit is configured to receive electrical power from a power supply and supply an electric current to the battery. The controller is configured to determine a plurality of thresholds of one or more electrical parameters of the battery. The plurality of thresholds has progressively increasing values. The controller is further configured to determine the one or more electrical parameters of the battery and control the charging circuit to progressively decrease a magnitude of the electric current supplied to the battery when the one or more electrical parameters progressively increase above each threshold from the plurality of thresholds.

### TECHNICAL FIELD

The present disclosure relates generally to personal protective equipment (PPE), and in particular to an article of PPE and a powered air purifying respirator.

### BACKGROUND

Articles of personal protective equipment (PPE) are used widely for protection against exposure to hazards that cause serious injuries and/or illnesses.

In some cases, an article of PPE may be a powered device (i.e., the article of PPE may include one or more components that require electrical power to operate) and may include a battery to power the one or more components thereof. However, the battery of conventional articles of PPE may take a long time (e.g., 4 hours to 8 hours) to fully charge from a discharged state. As a result, it may be desirable for the battery of the conventional articles of PPE to be removable so that a discharged battery can be replaced with a charged battery. However, during replacement of the battery, foreign and undesirable particles may enter and interfere with electrical contacts that interface with the battery.

Rapid charging of the battery may be particularly useful for the article of PPE that is portable, such as a powered air-purifying respirator. For example, it may be desirable for the battery of the article of PPE to be rapidly charged (e.g., 50% in 15 minutes) during a work break, so that the article of PPE can be used again after the work break. However, rapid charging may rise a temperature of the battery and cause the battery to overheat. Consequently, the battery may need to be cooled during rapid charging to prevent the battery from overheating.

Therefore, there may be a need of an article of PPE that allows rapid charging of its battery, that significantly reduces or prevents ingress of foreign and undesirable particles between the electrical contacts and the battery and prevents the battery from overheating during rapid charging.

### SUMMARY

In one aspect, the present disclosure provides an article of personal protective equipment (PPE). The article of PPE includes a battery configured to power one or more components of the article of PPE. The article of PPE further includes a charging circuit configured to receive electrical power from a power supply and supply an electric current to the battery. The article of PPE further includes a controller configured to determine a plurality of thresholds of one or more electrical parameters of the battery. The plurality of thresholds has progressively increasing values. The controller is further configured to determine the one or more electrical parameters of the battery. The controller is further configured to control the charging circuit to progressively decrease a magnitude of the electric current supplied to the battery when the one or more electrical parameters progressively increase above each threshold from the plurality of thresholds.

In another aspect, the present disclosure provides a powered air purifying respirator (PAPR). The PAPR includes a housing. The PAPR further includes a battery disposed within the housing and configured to power one or more components of the PAPR. The PAPR further includes a charging circuit disposed within the housing and configured to receive electrical power from a power supply and supply an electric current to the battery. The PAPR further includes a controller configured to determine a plurality of thresholds of one or more electrical parameters of the battery. The plurality of thresholds has progressively increasing values. The controller is further configured to determine the one or more electrical parameters of the battery. The controller is further configured to control the charging circuit to progressively decrease a magnitude of the electric current supplied to the battery when the one or more electrical parameters progressively increase above each threshold from the plurality of thresholds. The PAPR further includes a tubing disposed in fluid communication with the housing. The PAPR further includes a filter mounted on the housing. The PAPR further includes a fan disposed within the housing downstream of the filter and configured to drive air through the filter to provide safe air to a person via the tubing.

The details of one or more examples of the disclosure are set forth in the accompanying drawings and the description below. Other features, objects, and advantages of the disclosure will be apparent from the description and drawings, and from the claims.

### BRIEF DESCRIPTION OF THE DRAWINGS

Exemplary embodiments disclosed herein may be more completely understood in consideration of the following detailed description in connection with the following figures. The figures are not necessarily drawn to scale. Like numbers used in the figures refer to like components. However, it will be understood that the use of a number to refer to a component in a given figure is not intended to limit the component in another figure labeled with the same number.

FIG. 1 is a schematic side perspective view of an article of personal protective equipment (PPE) worn by a person;

FIG. 2 is a schematic block diagram of an article of PPE according to an embodiment of the present disclosure;

FIG. 3 is a graph depicting a charging process of a battery of the article of PPE with respect to time according to an embodiment of the present disclosure;

FIG. 4 is a schematic diagram of a portion of the article of PPE according to an embodiment of the present disclosure;

FIG. 5 is a schematic diagram of a portion of an article of PPE according to another embodiment of the present disclosure;

FIG. 6 is a schematic diagram of a portion of an article of PPE according to another embodiment of the present disclosure;

FIG. 7 is a schematic diagram of a portion of an article of PPE according to another embodiment of the present disclosure;

FIG. 8 is a schematic diagram of a portion of an article of PPE according to another embodiment of the present disclosure;

FIG. 9 is a schematic diagram of a portion of an article of PPE according to another embodiment of the present disclosure;

FIG. 10 is a schematic diagram of a portion of an article of PPE according to another embodiment of the present disclosure;

FIG. 11 is a schematic diagram of a portion of an article of PPE according to another embodiment of the present disclosure; and

FIG. 12 is a schematic diagram of a portion of an article of PPE according to another embodiment of the present disclosure.

### DETAILED DESCRIPTION

In the following description, reference is made to the accompanying figures that form a part thereof and in which various embodiments are shown by way of illustration. It is to be understood that other embodiments are contemplated and may be made without departing from the scope or spirit of the present disclosure. The following detailed description, therefore, is not to be taken in a limiting sense.

In the present disclosure, the following definitions are adopted.

As recited herein, all numbers should be considered modified by the term “about”. As used herein, “a,” “an,” “the,” “at least one,” and “one or more” are used interchangeably.

As used herein as a modifier to a property or attribute, the term “generally,”, unless otherwise specifically defined, means that the property or attribute would be readily recognizable by a person of ordinary skill but without requiring absolute precision or a perfect match (e.g., within +/−20% for quantifiable properties).

The term “substantially,” unless otherwise specifically defined, means to a high degree of approximation (e.g., within +/−10% for quantifiable properties) but again without requiring absolute precision or a perfect match.

The term “about,” unless otherwise specifically defined, means to a high degree of approximation (e.g., within +/−5% for quantifiable properties) but again without requiring absolute precision or a perfect match.

Terms such as same, equal, uniform, constant, strictly, and the like, are understood to be within the usual tolerances or measuring error applicable to the particular circumstance rather than requiring absolute precision or a perfect match.

As used herein, the terms “first” and “second” are used as identifiers. Therefore, such terms should not be construed as limiting of this disclosure. The terms “first” and “second” when used in conjunction with a feature or an element can be interchanged throughout the embodiments of this disclosure.

As used herein, when a first material is termed as “similar” to a second material, at least 90 weight % of the first and second materials are identical and any variation between the first and second materials comprises less than about 10 weight % of each of the first and second materials.

As used herein, “at least one of A and B” should be understood to mean “only A, only B, or both A and B”.

As used herein, the phrase “article of personal protective equipment” or “article of PPE” refers to any article that can be worn by an individual for the purpose of preventing or decreasing personal injury or health hazard to the individual. As it is to be worn by the individual, the article of PPE is portable. Examples of the article of PPE include safety glasses, safety goggles, face shields, face masks, respirators (such as a powered air purifying respirator), earplugs, earmuffs, gloves, suits, gowns, aprons, hard hats, etc.

As used herein, the term “battery” refers to an electrochemical storage device. A battery may include one or more electrochemical cells that convert stored chemical energy into electrical energy. A battery may be charged by a charging circuit that is controlled by a controller, and may provide electrical energy to one or more components, such as a fan, an indicator, and the like.

As used herein, the phrase “health of a battery” refers to an amount of energy that the battery is able to store and deliver in the full range of use cases, including higher or lower temperature or higher or lower current draw. For example, the health of a battery includes battery capacity, its voltage as a function of capacity, and its impedance across the useful voltage range. There exist commercially available battery management systems that determine a health of a battery, which could be used in managing rapid charging thresholds.

As used herein, the phrase “age of a battery” refers to an amount of time since the battery was manufactured.

As used herein, the phrase “charge cycle of a battery” refers to a consecutive charge and discharge of the battery or a consecutive discharge and charge of the battery. One complete charge cycle of the battery refers to a process of full charge and full discharge of the battery. It is customary in battery management systems to track the total capacity charged and or discharged and divide by a nominal battery capacity per cycle to track the total number of charge cycles of a battery.

As used herein, the term “battery capacity” refers to a measure (typically in amp-hr) of a charge stored by a battery. The battery capacity may represent a maximum amount of capacity that can be extracted from the battery under certain specified conditions.

As used herein, the term “rapid charging” refers to charging of a battery to a high state of charge (for example, 80%) in a short time (for example, 30 minutes).

As used herein, the term “controller” refers to a computing device that couples to one or more other devices, e.g., peripheral devices, motion drives, actuators, etc., and which may be configured to communicate with, e.g., to control, such devices.

In the present disclosure, currents may be expressed in terms of battery capacity. For a battery with a maximum capacity (Qₘₐₓ) of 2500 milliamp-hour (mAh), a “1 C” current would be 2500 mA, where the unit C or C-rate is a capacity expressed current in units of 1/hour to be multiplied by Qₘₐₓ to get the current in Ampere.

Articles of personal protective equipment (PPE) are commonly worn to minimize exposure to hazards that cause serious workplace injuries and illnesses. The articles of PPE may be worn by people while working in areas presenting personal injury or health hazard, such as areas where air may be contaminated with toxic or hazardous substances.

The present disclosure provides an article of PPE. The article of PPE includes a battery configured to power one or more components of the article of PPE. The article of PPE further includes a charging circuit configured to receive electrical power from a power supply and supply an electric current to the battery. The article of PPE further includes a controller configured to determine a plurality of thresholds of one or more electrical parameters of the battery. The plurality of thresholds has progressively increasing values. The controller is further configured to determine the one or more electrical parameters of the battery. The controller is further configured to control the charging circuit to progressively decrease a magnitude of the electric current supplied to the battery when the one or more electrical parameters progressively increase above each threshold from the plurality of thresholds.

The article of PPE of the present disclosure may rapidly charge the battery thereof. As a result, the battery of the article of PPE may be charged when required (e.g., during a work break), so that the article of PPE can be used again after a short period. Moreover, rapid charging may allow the battery to be designed as a non-removable battery. The non-removable battery may prevent ingress of foreign and undesirable particles between electrical contacts of the article of PPE and the battery.

As discussed above, the controller is configured to control the charging circuit to progressively decrease a magnitude of the electric current supplied to the battery when the one or more electrical parameters progressively increase above each threshold from the plurality of thresholds. This may decrease a risk of lithium-plating at an anode of the battery, thereby increasing a calendar life of the battery.

In some examples, the article of PPE (e.g., a powered air purifying respirator) may include a fan that performs a primary function thereof. In such examples, the article of PPE of the present disclosure may utilize the fan to cool the battery and/or the charging circuit to maintain their temperature below a threshold temperature. As a result, the battery and/or the charging circuit may not overheat during rapid charging.

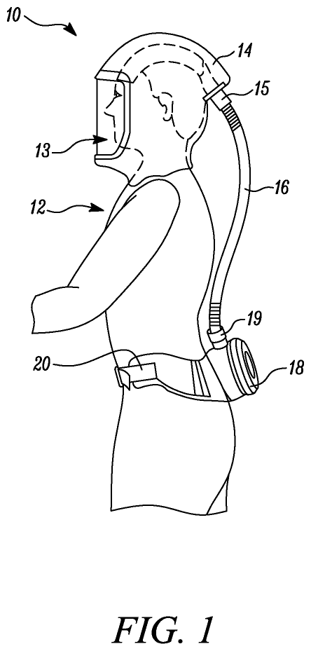

Referring now to figures, FIG. 1 illustrates an example of an article of personal protective equipment (PPE) 10 (hereinafter referred to as “the article 10”). Specifically, FIG. 1 illustrates a schematic perspective view of the article 10 worn by a person 12.

In the illustrated example of FIG. 1, the article 10 is a powered air purifying respirator (PAPR). Specifically, the article 10 includes a head or a face piece, such as a hood 14, a breathing tube 16, a turbo unit 18 (including a fan), a turbo support, such as a belt 20, and a turbo unit power source (not shown). The turbo unit power source may be a battery that powers one or more components (such as the fan) of the turbo unit 18.

The hood 14 may be worn on a head of the person 12 and may at least partially enclose the head of the person 12 to form a breathing zone 13, that is, an area around a nose and a mouth of the person 12, so that filtered air is directed to the breathing zone 13. The article 10 (PAPR in FIG. 1) may therefore provide respiratory protection to the person 12. Further, a turbo status indicator unit that houses turbo status indicators may be adapted to fit inside the hood 14 within a range of vision of the person 12 to indicate the current operating status of the turbo unit 18 (e.g., a speed of the fan of the turbo unit 18) to the person 12.

The turbo unit 18 may be attached to the belt 20 to secure the turbo unit 18 about a torso of the person 12. The turbo unit 18 may supply air to the hood 14 through the breathing tube 16, which is connected between an outlet 19 of the turbo unit 18 and an inlet 15 of the hood 14. Further, a turbo remote control unit (not shown), that houses turbo controls, may be adapted to be worn about a wrist of the person 12 to receive information or inputs from the person 12. Two or more of the turbo unit 18, the turbo status indicator unit, and the turbo remote control unit may be disposed in wireless communication with each other.

It may be noted that the article 10 may include any device, system, or apparatus that is worn on a body of the person 12 and provides protection to the person 12 in a hazardous environment. In other words, the article 10 is portable, such that the article 10 can be worn by the person 12 to provide protection to the person 12. For example, the article 10 may include respiratory protection apparatuses/devices, such as a self-contained breathing apparatus (SCBA), a non-powered air purifying respirator (APR), a hose line, a half facemask, a full facemask, a half face respirator, a full face respirator, and the like, to provide respiratory protection to the person 12. In another example, the article 10 may include hearing protection devices, such as earmuffs and earplugs, to provide hearing protection to the person 12. In another example, the article 10 may include vision protection devices, such as an eyewear, to provide vision protection to the person 12. In another example, the article 10 may include fall protection devices/apparatuses, such as a headgear and a harness, to provide fall protection to the person 12.

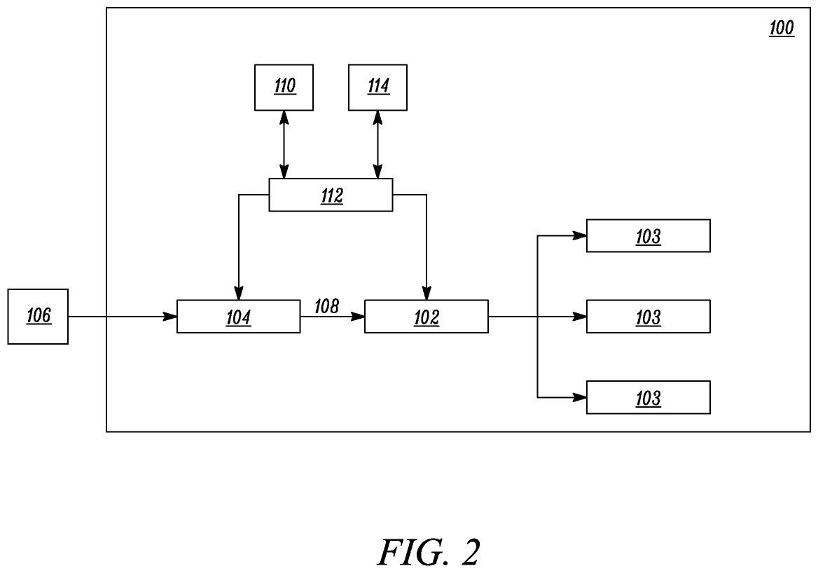

FIG. 2 illustrates a schematic block diagram of an article of PPE 100 (hereinafter referred to as “the article 100”) according to an embodiment of the present disclosure. Similar to as discussed above with reference to the article 10 of FIG. 1, the article 100 may include any device, system, or apparatus that is worn on a body of a person and provides protection to the person in a hazardous environment. Specifically, in some embodiments, the article 100 provides hearing protection. In some embodiments, the article 100 provides vision protection. In some embodiments, the article 100 provides fall protection. In some embodiments, the article 100 provides respiratory protection. The article 100 described hereinafter is a powered air purifying respirator (PAPR), however, the article 100 is not limited thereto.

The article 100 includes one or more components 103 that are electrically powered. The article 100 further includes a battery 102. The battery 102 is configured to power the one or more components 103 of the article 100. The one or more components 103 may include, for example, an electric motor, a light source, a personal alert safety system (PASS) unit, etc.

The battery 102 is rechargeable and can be recharged when partially or fully discharged. The battery 102 may include any suitable secondary battery, preferably having a high energy density. In some embodiments, the battery 102 may be a lithium-ion battery. The battery 102 may be made up of a plurality of electrochemical cells.

The article 100 further includes a charging circuit 104 configured to receive electrical power from a power supply 106. The power supply 106 may be any external power source, such as a power grid, an electric generator, an electricity storage means, such as an external battery, and the like. The charging circuit 104 is electrically coupled to the to the battery 102. The charging circuit 104 is further configured to supply an electric current 108 to the battery 102.

The article 100 further includes a controller 112. The controller 112 may be communicably coupled to the battery 102 and the charging circuit 104. The controller 112 is configured to determine one or more electrical parameters of the battery 102. In some embodiments, the one or more electrical parameters include a state of charge (SoC) of the battery 102. In some embodiments, the one or more electrical parameters include a voltage level of the battery 102. The controller 112 may continuously monitor the one or more electrical parameters of the battery 102 to determine the one or more electrical parameters in a present state thereof. For example, the controller 112 may monitor the SoC and a corresponding voltage level of the battery 102.

The controller 112 is further configured to control the charging circuit 104. Specifically, the controller 112 is configured to control the charging circuit 104 by adjusting a magnitude of the electrical current 108 supplied to the battery 102 by the charging circuit 104 based on the one or more electrical parameters of the battery 102.

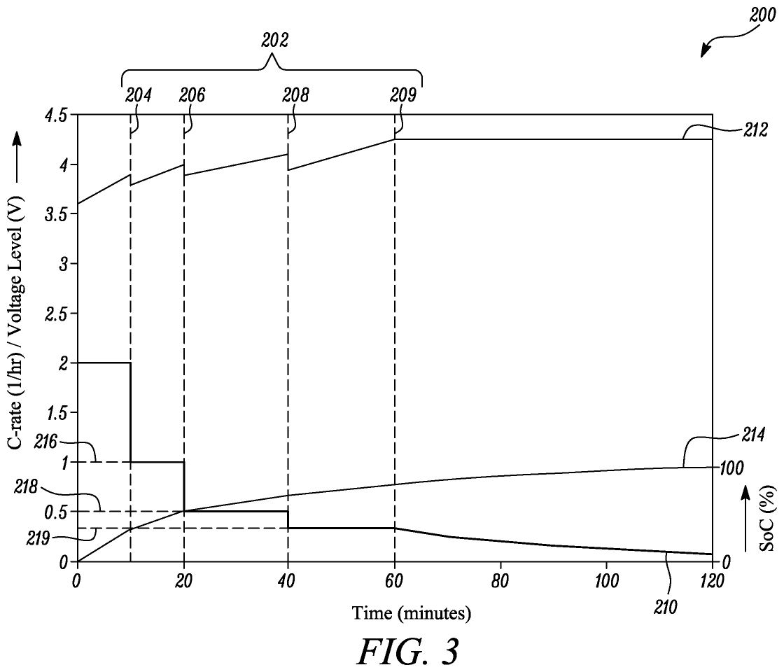

FIG. 3 illustrates a graph 200 depicting a charging process of the battery 102 (shown in FIG. 2) of the article 100 with respect to time according to an embodiment of the present disclosure. The left Y-axis depicts C-rate (1/hour) during charging of the battery 102, and the voltage level (in Volts) of the battery 102 during charging, while the right Y-axis depicts the SoC (in %, from 0% to 100%) of the battery 102. Time (in minutes) is depicted on the X-axis.

Referring to FIGS. 2 and 3, the graph 200 includes a first curve 210 depicting a variation of the magnitude of the electric current 108 (in C-rate) supplied to the battery 102 with respect to time (in minutes). The graph 200 further includes a second curve 212 depicting a variation of the voltage level (in Volts) of the battery 102 with respect to time, and a third curve 214 depicting the SoC (in %) of the battery 102 with respect to time.

The controller 112 is further configured to determine a plurality of thresholds 202 of the one or more electrical parameters of the battery 102. The plurality of thresholds 202 has progressively increasing values. In other words, a subsequent threshold 202 from the plurality of thresholds 202 has a greater value than a prior threshold 202 from the plurality of thresholds 202. For example, the subsequent threshold 202 may be 25% SoC and the prior threshold 202 may be 10% SoC.

The controller 112 may determine the plurality of thresholds 202 based on numerous factors. Specifically, in some embodiments, the controller 112 is further configured to determine the plurality of thresholds 202 of the one or more electrical parameters based on one or more of a health of the battery 102, a temperature of the battery 102, an impedance of the battery 102, an age of the battery 102, and a number of charge cycles of the battery 102. For example, the plurality of thresholds 202 may be lowered in case the health of the battery 102 is low and/or the temperature of the battery 102 is low, as low health of the battery 102 and low temperature of the battery 102 may increase a risk of lithium plating. The controller 112 may determine the plurality of thresholds 202 based on a rate of change of the numerous factors described above.

The health of the battery 102 may be dependent on factors including the number of charge cycles of the battery 102, the age of the battery 102, and temperatures in which the battery 102 has been used in. One approximation for health of the battery 102 is the impedance of the battery 102, which can be estimated in many ways, such as a change in the voltage of the battery 102 on transitioning from a charge current to zero current, both immediately and as a function of time.

As discussed above, the controller 112 is configured to determine the one or more electrical parameters of the battery 102. In other words, the controller 112 is configured to determine an instantaneous or a present value of the one or more electrical parameters. For example, the controller 112 may determine the instantaneous value of the SoC of the battery 102 and/or the voltage level of the battery 102.

The controller 112 is further configured to control the charging circuit 104 to progressively decrease the magnitude of the electric current 108 supplied to the battery 102 when the one or more electrical parameters progressively increase above each threshold 202 from the plurality of thresholds 202. The electric current 108 may be supplied to the battery 102 in “steps” as the one or more electrical parameters progressively increase above each threshold 202 from the plurality of thresholds 202. In some examples, the controller 112 may control the charging circuit 104 based on a charging algorithm including features described herein.

Therefore, the controller 112 may control the charging circuit 104 to rapidly charge the battery 102 by supplying the electric current 108 having a high magnitude when the one or more electrical parameters (e.g., SoC) of the battery 102 has a low magnitude. For example, as depicted by the first curve 210, the controller 112 may charge the battery 102 from 0% SoC to about 50% SoC in about 20 minutes by providing the electric current 108 having a high magnitude (2 C-rate for 10 minutes and 1 C-rate for subsequent 10 minutes). As a result, the battery 102 may be quickly charged from a low SoC when required.

It may be beneficial to charge the battery 102 by progressively decreasing the magnitude of the electric current 108 supplied to the battery 102 when the SoC (or the voltage level) of the battery 102 progressively increases above each threshold 202 from the plurality of thresholds 202. For example, in cases where the battery 102 is a lithium-ion battery, an anode, a cathode, and a separator of the battery 102 may not be perfectly homogeneous over their entire area. As a result, there may be some regions where a risk of lithium plating is greater. For example, if one region has a low resistance cathode and a low resistance separator, but a high resistance anode, then the one region may be at an increased risk of lithium plating. When a high magnitude of the electric current 108 is supplied, the voltage level at which lithium may start to plate at a higher risk region may be lower than the corresponding voltage level for a low magnitude of the electric current 108. Also, as the SoC rises, the average anode potential gets progressively closer to the lithium-plating potential, thus a magnitude of the electric current 108 that would cause lithium-plating gets lower. Therefore, the risk of lithium-plating at the anode may be mitigated by progressively decreasing the magnitude of the electric current 108 supplied to the battery 102 when the voltage level of the battery 102 progressively increase above each threshold 202 from the plurality of thresholds 202.

Additionally, the controller 112 may adjust the magnitude of the electric current supplied to the battery 102 may be based on numerous factors. In some embodiments, the magnitude of the electric current supplied to the battery 102 may be based on one or more of the health of the battery 102, the temperature of the battery 102, the impedance of the battery 102, the age of the battery 102, and the number of charge cycles of the battery 102. The magnitude of the electric current may be adjusted to ensure safe charging of the battery 102 and to extend a useful age of the battery 102.

Further, rapid charging may allow the battery 102 to be non-removable, as compared to slow charging that compels the use of removable batteries that are designed to be replaced when discharged. Therefore, in some embodiments, the battery 102 of the article 100 is non-removable. Specifically, the article 100 may be designed such that the battery 102 is non-removable. The non-removable configuration of the battery 102 may prevent of ingress of foreign and undesirable particles between electrical contacts (not shown) of the article 100 and the battery 102. Therefore, the article 100 may have a stable electrical interface with the battery 102. However, in some cases, the article 100 may be designed such that the battery 102 may be removable.

As shown in FIG. 3, in some embodiments, the plurality of thresholds 202 includes at least a first threshold 204, a second threshold 206 greater than the first threshold 204, and a third threshold 208 greater than the second threshold 206. In some embodiments, the controller 112 is further configured to control the charging circuit 104 to maintain the magnitude of the electric current 108 at a substantially constant value when the one or more electrical parameters are between two adjacent thresholds 202 (for example, between the first and second thresholds 204, 206) from the plurality of thresholds 202. Specifically, in some embodiments, the controller 112 is further configured to control the charging circuit 104, such that the electric current 108 is maintained at a first magnitude 216 (about 1 C-rate in FIG. 3) when the one or more electrical parameters are between the first threshold 204 and the second threshold 206, and the electric current 108 is maintained at a second magnitude 218 (about 0.5 C-rate in FIG. 3) that is less than the first magnitude 216 when the one or more electrical parameters are between the second threshold 206 and the third threshold 208. In some embodiments, the plurality of thresholds 202 may further include a fourth threshold 209 greater than the third threshold 208, and the controller 112 may be further configured to control the charging circuit 104, such that the electric current 108 is maintained at a third magnitude 219 (about 0.25 C-rate in FIG. 3) when the one or more electrical parameters are between the third threshold 208 and the fourth threshold 209.

Furthermore, subsequent to the fourth threshold 209, the magnitude of the electric current 108 supplied to the battery 102 may be progressively decreased to 0 C-rate with further increase in the one or more electrical parameters. Providing low magnitude of the electric current 108 to the battery 102 when the one or more electrical parameters have a high value may further extend the useful age of the battery 102. In the example shown in FIG. 3, a portion of charging of the battery 102 up until the fourth threshold 209 may be referred to as “rapid charging portion” and a portion of charging of the battery 102 after the fourth threshold 209 may be referred to as “normal charging portion”.

Referring back to FIG. 2, in the illustrated embodiment of FIG. 2, the article 100 further includes a fan 110. Furthermore, the controller 112 is communicably coupled to and configured to control the fan 110. In some embodiments, the fan 110 is configured to perform a primary function of the article 100. As discussed above, the article 100 is the PAPR. Therefore, the primary function of the article 100 is to provide safe air to a person wearing the article 100.

In some embodiments, the controller 112 is further configured to control the fan 110 to indicate partial or full completion of charging of the battery 102. Specifically, in some embodiments, the controller 112 is further configured to switch off or pulse the fan 110 to indicate partial or full completion of charging of the battery 102. In some cases, the controller 112 may be configured to switch off or pulse the fan 110 to indicate that rapid charging portion of the battery 102 is completed.

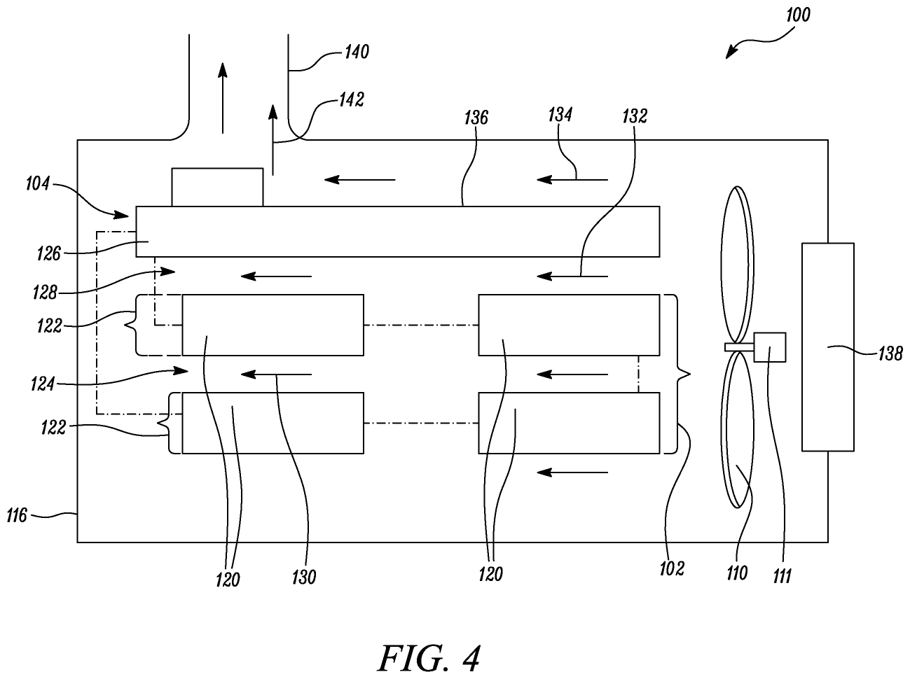

Moreover, in the illustrated embodiment of FIG. 2, the article 100 further includes an indicator 114 communicably coupled to the controller 112. In some embodiments, the controller 112 is further configured to indicate the state of charge of the battery 102 via the indicator 114. The indicator 114 may be a sensory indicator, such as a visual indicator, an audible indicator, a tactile indicator, and the like. For example, the indicator 114 may include a set of light emitting diodes that indicate the SoC of the battery 102 by flashing, changing color, or changing intensity. Other examples of the indicator 114 include a piezo buzzer to produce sound upon charge completion (i.e., 100% SoC) of the battery 102. Further aspects of the article 100 will be described with reference to FIG. 4.

FIG. 4 illustrates a schematic diagram of a portion of the article 100 according to an embodiment of the present disclosure. The portion of the article 100 illustrated in FIG. 4 may correspond to the turbo unit 18 of FIG. 1.

In the illustrated embodiment of FIG. 4, the article 100 includes a housing 116 receiving the fan 110, the battery 102, and the charging circuit 104 therein. In other words, in the illustrated embodiment of FIG. 4, the battery 102 is disposed within the housing 116, the charging circuit 104 is disposed within the housing 116, and the fan 110 is disposed within the housing 116. The article 100 may further include a motor 111 (e.g., an electric motor) disposed within the housing 116 and configured to drive the fan 110.

In some embodiments, the fan 110 is further configured to cool at least one of the battery 102 and the charging circuit 104. Advantageously, the article 100 may utilize the fan 110 to cool the battery and/or the charging circuit 104 in addition to performing the primary function of the article 100. In the illustrated embodiment of FIG. 4, the fan 110 is configured to cool each of the battery 102 and the charging circuit 104.

In the illustrated embodiment of FIG. 4, the battery 102 includes a plurality of electrochemical cells 120. Electrical connections between each of the plurality of electrochemical cells 120 and the charging circuit 104 are depicted by dash-dot lines in FIG. 4.

Specifically, in the illustrated embodiment of FIG. 4, the plurality of electrochemical cells 120 is arranged in a plurality of cell rows 122 spaced apart from each other. The plurality of cell rows 122 defines one or more cell passages 124 therebetween. In the illustrated embodiment of FIG. 4, the electrochemical cells 120 is arranged in two cell rows 122 separated by one cell passage 124. Each cell row 122 includes two electrochemical cells 120. Further, in the illustrated embodiment of FIG. 4, the charging circuit 104 includes a printed circuit board (PCB) 126 disposed adjacent to one cell row 122 from the plurality of cell rows 122, such that a board passage 128 is defined between the PCB 126 and the one cell row 122.

In the illustrated embodiment of FIG. 4, the board passage 128 is disposed substantially parallel to the one or more cell passages 124, such that the fan 110 is configured to direct a first flow of air 130 (shown by an arrow) through the one or more cell passages 124, a second flow of air 132 (shown by an arrow) through the board passage 128, and a third flow of air 134 (shown by an arrow) along a surface 136 of the PCB 126 opposite to the board passage 128. In other words, in the illustrated embodiment of FIG. 4, the fan 110 is configured to generate a flow of air that is divided into the first flow of air 130, the second flow of air 132, and the third flow of air 134, such that the first flow of air 130 is directed through the cell passage 124, the second flow of air 132 is directed through the board passage 128, and the third flow of air 134 is directed along the surface 136 of the PCB 126 opposite to the board passage 128.

In some embodiments, the fan 110 is further configured to maintain a temperature of at least one of the battery 102 and the charging circuit 104 below a threshold temperature. The threshold temperature corresponds to a predetermined threshold temperature below which the fan 110 is configured to maintain at least one of the battery 102 and the charging circuit 104. In some embodiments, the threshold temperature is from about 35 degrees Celsius to about 55 degrees Celsius. In some embodiments, the threshold temperature may be about 40 degrees Celsius, about 45 degrees Celsius, about 50 degrees Celsius, or 55 about degrees Celsius. As a result, the battery 102 and/or the charging circuit 104 may be prevented from overheating due to excess heat generated during rapid charging. Further, it may be ensured that the charging circuit 104 does not raise the temperature of the battery 102 over the threshold temperature and the battery 102 may remain at an optimal temperature during rapid charging. In the illustrated embodiment of FIG. 4, the fan 110 is configured to maintain a temperature of each of the battery 102 and the charging circuit 104 below the threshold temperature.

In the illustrated embodiment of FIG. 4, the article 100 further includes a filter 138. The filter 138 may be a swappable filter cartridge that is typically used in PAPRs. For example, the filter 138 may be a swappable gas and vapor cartridge. The filter 138 may filter contaminants from air passing therethrough. In the illustrated embodiment of FIG. 4, the filter 138 is mounted on the housing 116 upstream of the fan 110. In other words, the fan 110 is disposed within the housing 116 downstream of the filter 138. Further, the fan 110 is disposed between the filter 138 and the battery 102.

In the illustrated embodiment of FIG. 4, the article 100 further includes a tubing 140 disposed in fluid communication with the housing 116. As discussed above, the primary function of the article 100 is to provide safe air 142 (shown by an arrow) to a person (e.g., the person 12 of FIG. 1) wearing the article 100. The safe air 142 refers to the air that is filtered by the filter 138 and that is safe to breathe. Thus, the fan 110 is further configured to drive air through the filter 138 to provide the safe air 142 to the person via the tubing 140.

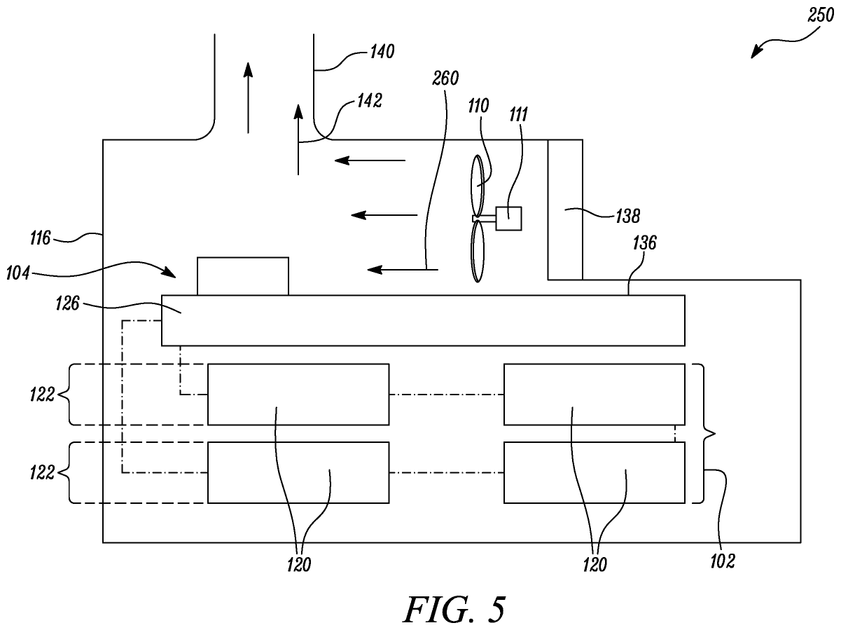

FIG. 5 illustrates a schematic diagram view of a portion of an article of PPE 250 (hereinafter, “the article 250”) according to another embodiment of the present disclosure.

The article 250 is similar to the article 100 of FIG. 4, with like elements designated by like reference numerals. However, the article 250 has a different configuration of the fan 110 as compared to the article 100.

In the illustrated embodiment of FIG. 5, the fan 110 is received within the housing 116, such that the fan 110 is configured to cool the charging circuit 104. The charging circuit 104 may be a primary source of heat and may be prone to overheating during rapid charging of the battery 102. In the illustrated embodiment of FIG. 5, the fan 110 is configured to direct a flow of air 260 (shown by an arrow) along the surface 136 of the PCB 126 opposite to the board passage 128. The charging circuit 104 may therefore be effectively cooled and kept closer to an ambient temperature (e.g., the threshold temperature). Advantageously, the article 250 may utilize the fan 110 to cool the charging circuit 104 in addition to performing the primary function of the article 250 (i.e., provide respiratory protection).

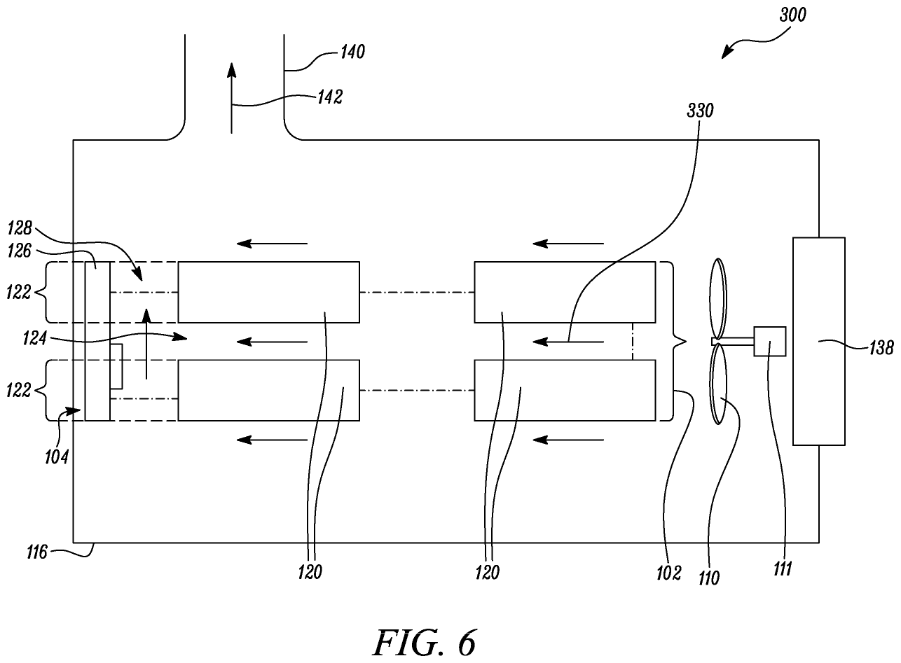

FIG. 6 illustrates a schematic diagram of a portion of an article of PPE 300 (hereinafter, “the article 300”) according to another embodiment of the present disclosure.

The article 300 is similar to the article 100 of FIG. 4, with like elements designated by like reference numerals. However, the article 300 has a different arrangement of the PCB 126 as compared to the article 100.

Specifically, in the illustrated embodiment of FIG. 6, the PCB 126 is disposed downstream of the plurality of electrochemical cells 120, such that the board passage 128 is disposed substantially perpendicular to and downstream of the one or more cell passages 124. Further, in the illustrated embodiment of FIG. 6, the fan 110 is configured to direct a flow of air 330 (shown by an arrow) through the one or more cell passages 124. Moreover, in the illustrated embodiment of FIG. 6, the board passage 128 is configured to receive the flow of air 330 from the one or more cell passages 124. As a result, both the battery 102 and the charging circuit 104 may be cooled by the fan 110.

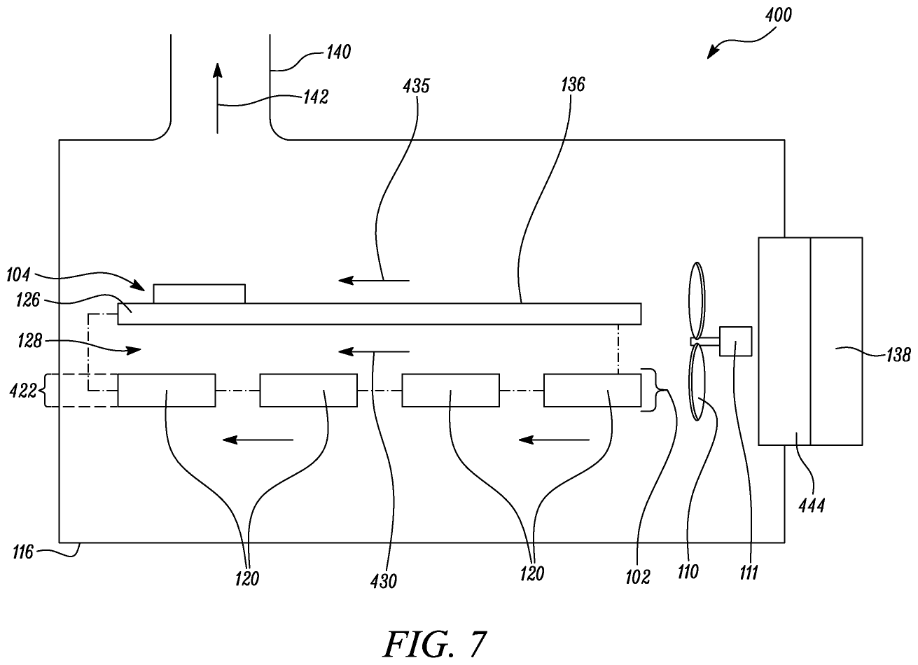

FIG. 7 illustrates a schematic diagram of a portion of an article of PPE 400 (hereinafter, “the article 400”) according to another embodiment of the present disclosure.

The article 400 is similar to the article 100 of FIG. 4, with like elements designated by like reference numerals. However, the article 400 has a different arrangement of the plurality of electrochemical cells 120 of the battery 102.

Specifically, in the illustrated embodiment of FIG. 7, the battery 102 includes the plurality of electrochemical cells 120 arranged in a single cell row 422. Further, in the illustrated embodiment of FIG. 7, the charging circuit 104 includes the PCB 126 disposed substantially parallel to and adjacent to the single cell row 422, such that the board passage 128 is defined between the PCB 126 and the single cell row 422. Furthermore, in the illustrated embodiment of FIG. 7, the fan 110 is configured to direct a flow of air 430 (shown by an arrow) to the board passage 128. Furthermore, the fan 110 is configured to direct a flow of air 435 (shown by an arrow) along the surface 136 of the PCB 126 opposite to the board passage 128.

Moreover, in the illustrated embodiment of FIG. 7, the article 400 further includes a charging filter 444 disposed upstream of the fan 110. In such embodiments, the filter 138 may be disposed adjacent to the charging filter 444. In the illustrated embodiment of FIG. 7, the filter 138 is disposed on the charging filter 444.

The charging filter 444 may be a “dust only filter” that filters air passing therethrough. As discussed above, the filter 138 may be a gas and vapor cartridge. As gas and vapor cartridges may have a defined run time or air volume exchange, it may be preferential to remove them during charging of the battery 102. The charging filter 444 may therefore be left on while the filter 138 is removed during charging of the battery 102.

Referring to FIGS. 2 and 7, in some embodiments, the controller 112 (shown in FIG. 2) is further configured to detect the charging filter 444. The controller 112 may detect the charging filter 444 via any suitable method, such as an electrical contact, a mechanical contact, and a non-contact method.

The electrical contact method may include passing electrical current through a circuitry of the charging filter 444 via electrical contacts disposed on the charging filter 444. As a result, the controller 112 may detect a presence of the charging filter 444. The electrical contacts of the charging filter 444 may include metallic contacts or circuit boards. As a less expensive solution, the electrical contacts on the charging filter 444 may include a conductive ink label. Detection of the charging filter 444 by the electrical contact method may vary in complexity, ranging from very simple, by directly shorting of one set of electrical contacts (e.g., electrical contacts disposed on the housing 116) to the electrical contacts of the charging filter 444, or more complicated, by placing an impedance between the one set of electrical contacts and the electrical contacts of the charging filter 444. The circuitry of the charging filter 444 may be simple resistive or reactive circuitry, or more complicated digital signaling, e.g., an authentication circuit to ensure that the charging filter 444 is not counterfeit.

The mechanical contact method may include detection of actuation of mechanical switches disposed on the charging filter 444.

The non-contact method may utilize one or more magnets disposed on the charging filter 444 coupling to one or more magnetic sensing elements disposed on the housing 116 in the form of a reed switch or hall effect sensor, the latter having either an on/off response or by measuring characteristics of a magnetic field in the form of intensity or measuring angle of the magnetic field.

The non-contact method may alternatively utilize detection using light, i.e., detecting a presence or absence of reflection from one or more reflective patches disposed on the charging filter 444 reflecting light to one or more reflective sensors disposed on the housing 116. The one or more reflective sensors may further be capable of detecting the spectra of reflected light from the one or more reflective patches, i.e., a color of the one or more reflective patches to determine a type of the charging filter 444. The non-contact method may alternatively utilize passive inductive-capacitive tank circuits disposed on the charging filter 444 and an excitation and measurement circuit disposed on the housing 116.

In some embodiments, the controller 112 is configured to detect the charging filter 444 via a radio frequency identification (RFID) communication protocol. In some embodiments, the controller 112 is configured to detect the charging filter 444 via a momentary switch or a presence-detection sensor (e.g., an optical sensor, an ultrasound sensor, a radio-frequency sensor, etc.). For example, the momentary switch may be actuated when the charging filter 444 is mounted, and the actuation of the momentary switch may be detected by the controller 112 to detect the charging filter 444.

In some embodiments, the controller 112 is further configured to operate the fan 110 during charging of the battery 102 to cool at least one of the battery 102 and the charging circuit 104 only upon detection of the charging filter 444. This may ensure that the fan 110 only drives clean air to cool the battery 102 and/or the charging circuit 104. This may particularly be important in cases where the article 400 provides respiratory protection.

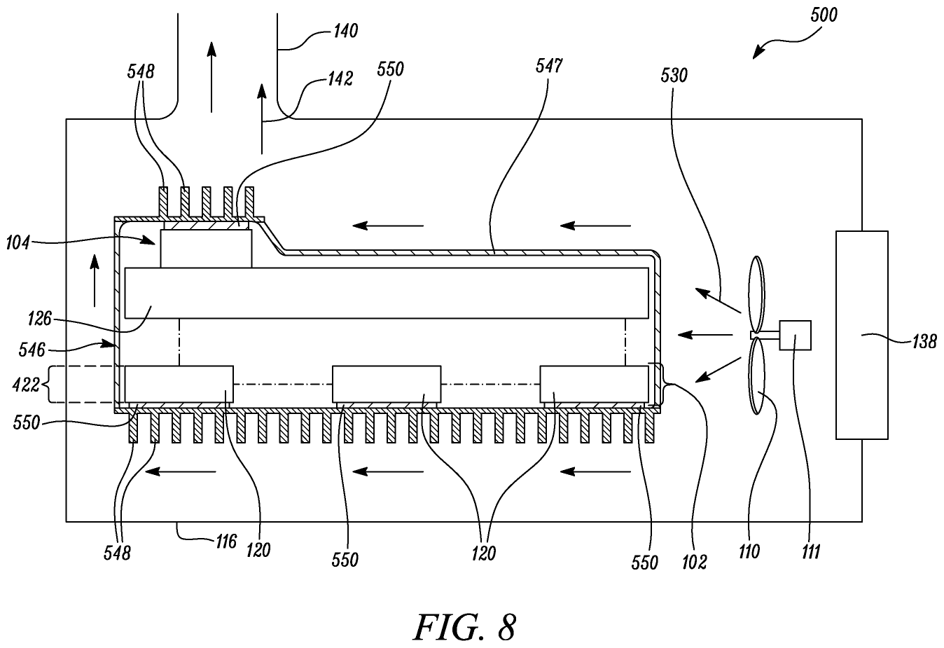

FIG. 8 illustrates a schematic diagram of a portion of an article of PPE 500 (hereinafter, “the article 500”) according to another embodiment of the present disclosure.

The article 500 is similar to the article 400 of FIG. 7, with like elements designated by like reference numerals. However, the article 500 further includes a thermally conductive wall 546 thermally coupled to at least one of the battery 102 and the charging circuit 104. Further, in some embodiments, the fan 110 is configured to cool at least one of the battery 102 and the charging circuit 104 by supplying air 530 (shown by an arrow) to the thermally conductive wall 546.

Specifically, in the illustrated embodiment of FIG. 8, the thermally conductive wall 546 is thermally coupled to each of the battery 102 and the charging circuit 104. Further, in the illustrated embodiment of FIG. 8, the fan 110 is configured to cool each of the battery 102 and the charging circuit 104 by supplying the air 530 to the thermally conductive wall 546. In some embodiments, the thermally conductive wall 546 includes a thermally conductive plastic 547, a metallic heatsink 548, or a combination thereof. For example, a portion of the thermally conductive wall 546 may be made of the thermally conductive plastic 547 and a portion of the thermally conductive wall 546 may be made of the metallic heatsink 548. The thermally conductive plastic 547 may include any plastic material that is thermally conductive, such as a carbon loaded plastic. In FIG. 8, the portion of the thermally conductive wall 546 made of the metallic heatsink 548 and the portion of the thermally conductive wall 546 made of the thermally conductive plastic 547 have different cross-hatching for clarity purpose.

The metallic heatsink 548 may preferably be substantially made of aluminum or copper. The thermally conductive wall 546 may increase a rate of heat flow away from the battery 102 and the charging circuit 104. Additionally, the thermally conductive wall 546 may provide a closed air space to the battery 102 and the charging circuit 104 by enclosing each of the battery 102 and the charging circuit 104.

Furthermore, in some embodiments, the article 500 further includes a thermal-interface material 550 (shown by cross-hatching) disposed between and contacting the thermally conductive wall 546 and at least one of the battery 102 and the charging circuit 104. The thermal-interface material 550 may thermally couple the thermally conductive wall 546 with the battery 102 and/or the charging circuit 104. The thermal-interface material 550 may improve a heat transfer rate between the charging circuit 104 and the thermally conductive wall 546, and between the plurality of electrochemical cells 120 and the thermally conductive wall 546. The thermal-interface material 550 may include, for example, a phase change material, metallic material, carbon-loaded polymer, a liquid, a thermal paste, etc.

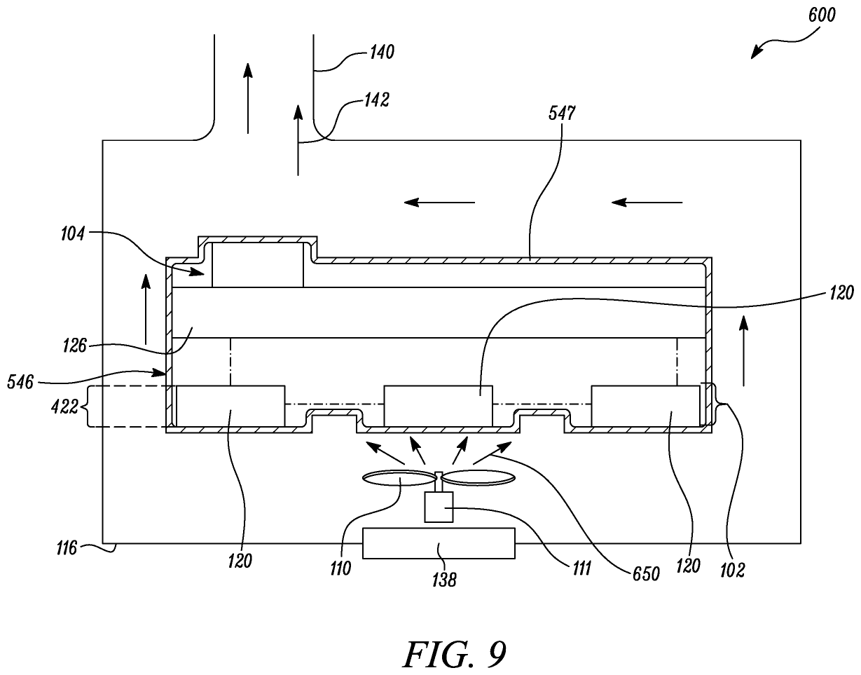

FIG. 9 illustrates a schematic diagram of a portion of an article of PPE 600 (hereinafter, “the article 600”) according to another embodiment of the present disclosure.

The article 600 is similar to the article 500 of FIG. 8, with like elements designated by like reference numerals. However, the article 600 has a different configuration from the article 500 with respect to the thermally conductive wall 546 and a relative positioning of the fan 110.

Specifically, in the illustrated embodiment of FIG. 9, the thermally conductive wall 546 (shown by cross-hatching) is entirely made of the thermally conductive plastic 547. Further, in the illustrated embodiment of FIG. 9, the fan 110 is disposed adjacent to the battery 102 and outside the thermally conductive wall 546. Moreover, the fan 110 is configured to cool the battery 102 and the charging circuit 104 by supplying air 650 to the thermally conductive wall 646.

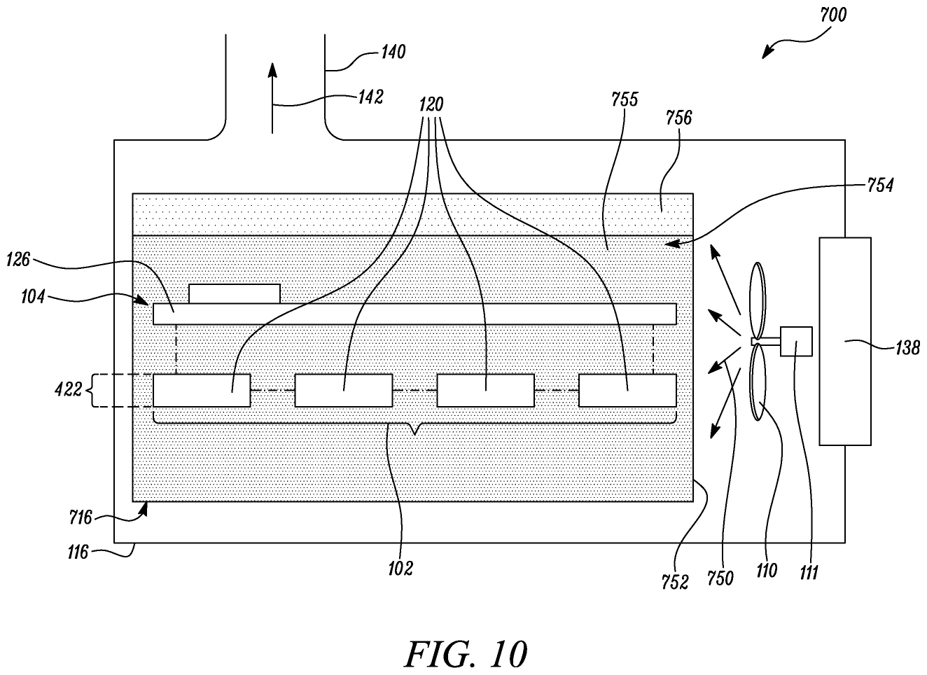

FIG. 10 illustrates a schematic diagram of a portion of an article of PPE 700 (hereinafter, “the article 700”) according to another embodiment of the present disclosure.

The article 700 is similar to the article 400 of FIG. 7, with like elements designated by like reference numerals. However, the article 700 further includes a hermetically sealed housing 716. The hermetically sealed housing 716 is disposed within the housing 116. Further, the battery 102 and the charging circuit 104 are disposed within the hermetically sealed housing 716.

In the illustrated embodiment of FIG. 10, the fan 110 is disposed outside the hermetically sealed housing 716 and configured to supply air 750 (shown by an arrow) to an external surface 752 of the hermetically sealed housing 716.

In the illustrated embodiment of FIG. 10, the article 700 further includes a phase-change material 754 (shown by dots) disposed within the hermetically sealed housing 716. The phase-change material 754 may contact at least one of the battery 102 and the charging circuit 104. The battery 102 and/or the charging circuit 104 may heat the phase-change material 754 and eventually cause a change in a phase (e.g., a solid to liquid transition, a liquid to vapor transition, etc.) of the phase-change material 754. The phase-change material 754 may therefore absorb heat from battery 102 and/or the charging circuit 104 when the phase-change material 754 changes the phase thereof (latent heat), thereby cooling the battery 102 and/or the charging circuit 104. Or, in the case of the liquid phase-change material, the phase-change material 754 may absorb heat from the battery 102 and/or the charging circuit 104 and rapidly move that heat away by convection to be cooled near the hermetically sealed housing 716 by the air-stream (i.e., the air 750).

In some embodiments, the phase-change material 754 is configured to maintain a temperature of at least one of the battery 102 and the charging circuit 104 below a threshold temperature. In some embodiments, the threshold temperature may be between 30 degrees Celsius and 55 degrees Celsius. In some embodiments, the threshold temperature may be about 35 degrees Celsius, about 40 degrees Celsius, about 45 degrees Celsius, or about 50 degrees Celsius.

In some embodiments, at least one of the charging circuit 104 and the battery 102 is in contact with the phase-change material 754. In the illustrated embodiment of FIG. 10, the phase-change material 754 includes a dielectric liquid 755. Further, in the illustrated embodiment of FIG. 10, each of the charging circuit 104 and the battery 102 is in contact with the dielectric liquid 755. Specifically, in the illustrated embodiment of FIG. 10, each of the charging circuit 104 and the battery 102 are submerged in the dielectric liquid 755. Therefore, the dielectric liquid 755 may convert into vapors 756 when heated due to a temperature of the charging circuit 104 and the battery 102. The vapors 756 may change phase back to the dielectric liquid 755 when cooled.

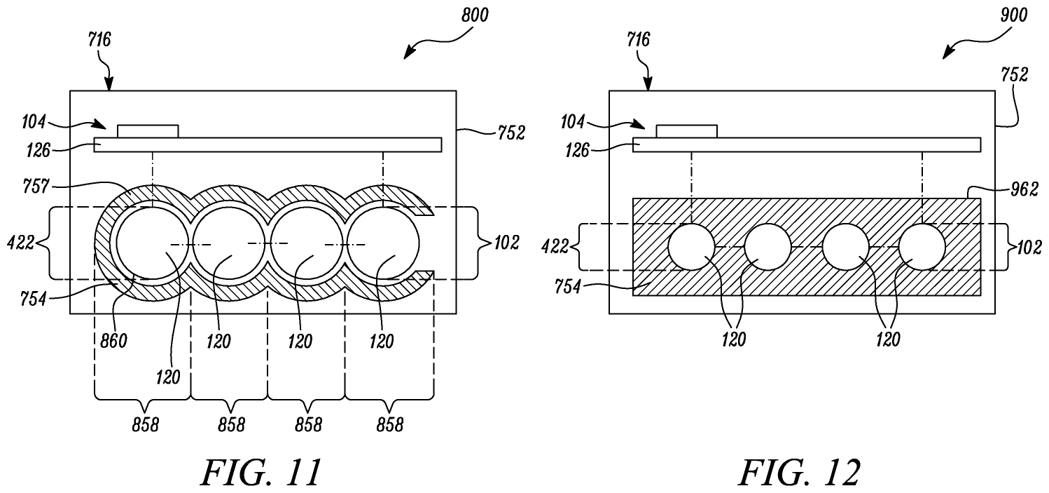

FIG. 11 illustrates a schematic diagram of a portion of an article of PPE 800 (hereinafter, “the article 800”) according to another embodiment of the present disclosure. Specifically, FIG. 11 illustrates a schematic diagram of the hermetically sealed housing 716 of the article 800, with other elements of the article 800 not shown for illustrative purposes. The article 800 is similar to the article 700 of FIG. 10, with like elements designated by like reference numerals. However, the article 800 has a different configuration of the phase-change material 754 as compared to the article 700.

Specifically, in the illustrated embodiment of FIG. 11, the phase-change material 754 (shown by cross-hatching in FIG. 11) includes a plurality of segments 858 disposed adjacent to each other. Further, each segment 858 directly engages and at least partially surrounds a corresponding electrochemical cell 120 from the plurality of electrochemical cells 120. Each segment 858 has a cross-sectional shape that at least partially conforms to an outer surface 860 of the corresponding electrochemical cell 120. The phase-change material 754 may include a wax material 757.

FIG. 12 illustrates a schematic diagram of a portion of an article of PPE 900 (hereinafter, “the article 900”) according to another embodiment of the present disclosure. Specifically, FIG. 12 illustrates a schematic diagram of the hermetically sealed housing 716 of the article 900, with other elements of the article 900 not shown for illustrative purposes. The article 900 is substantially similar to the article 800 of FIG. 11, with like elements designated by like reference numerals. However, the article 900 has a different configuration of the phase-change material 754 as compared to the article 700.

In the illustrated embodiment of FIG. 11, the phase-change material 754 (shown by cross-hatching in FIG. 12) directly engages and surrounds the battery 102. Specifically, the phase-change material 754 directly engages and surrounds the plurality of electrochemical cells 120. Furthermore, the phase-change material 754 defines an outer surface 962 distal to the battery 102. The outer surface 962 has a rectangular cross-sectional shape. However, in some embodiments, the outer surface 962 may have a circular cross-sectional shape, a square cross-sectional shape, a trapezoidal cross-sectional shape, a polygonal cross-sectional shape, or any other suitable cross-sectional shape.

Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. An article of personal protective equipment (PPE), the article of PPE comprising:
a battery configured to power one or more components of the article of PPE;
a charging circuit configured to receive electrical power from a power supply and supply an electric current to the battery;
a fan configured to cool at least one of the battery and the charging circuit, wherein the fan is configured to perform a primary function of the article of PPE; and
a controller configured to:
determine a plurality of thresholds of one or more electrical parameters of the battery, the plurality of thresholds having progressively increasing values;
determine the one or more electrical parameters of the battery; and
control the charging circuit to progressively decrease a magnitude of the electric current supplied to the battery when the one or more electrical parameters progressively increase above each threshold from the plurality of thresholds, wherein the controller is communicably coupled to and configured to control the fan.

2. The article of PPE of claim 1, wherein the controller is further configured to control the charging circuit to maintain the magnitude of the electric current at a substantially constant value when the one or more electrical parameters are between two adjacent thresholds from the plurality of thresholds.

3. The article of PPE of claim 1, wherein the plurality of thresholds comprises at least a first threshold, a second threshold greater than the first threshold, and a third threshold greater than the second threshold, and wherein the controller is further configured to control the charging circuit, such that:
the electric current is maintained at a first magnitude when the one or more electrical parameters are between the first threshold and the second threshold; and
the electric current is maintained at a second magnitude that is less than the first magnitude when the one or more electrical parameters are between the second threshold and the third threshold.

4. The article of PPE of claim 1, wherein the controller is further configured to determine the plurality of thresholds of the one or more electrical parameters based on one or more of a health of the battery, a temperature of the battery, an impedance of the battery, an age of the battery, and a number of charge cycles of the battery.

5-6. (canceled)

7. The article of PPE of claim 1, wherein the article of PPE provides at least one of respiratory protection, hearing protection, vision protection, and fall protection.

8-10. (canceled)

11. The article of PPE of claim 1, wherein the battery of the article of PPE is non-removable.

12-14. (canceled)

15. The article of PPE of claim 1, further comprising a filter, wherein the primary function of the article of PPE is to provide safe air to a person wearing the article of PPE, and wherein the fan is configured to drive air through the filter to provide the safe air to the person.

16. The article of PPE of claim 15, further comprising a housing receiving the fan, the battery, and the charging circuit therein, wherein the filter is mounted on the housing.

17. The article of PPE of claim 1, wherein the battery comprises a plurality of electrochemical cells, and wherein the charging circuit comprises a printed circuit board disposed adjacent to the plurality of electrochemical cells cell rows, such that a board passage is defined between the printed circuit board and the electrochemical cells, wherein the fan is configured to direct a flow of air to the board passage.

18-20. (canceled)

21. The article of PPE of claim 1, further comprising a thermally conductive wall thermally coupled to at least one of the battery and the charging circuit, and wherein the fan is configured to cool at least one of the battery and the charging circuit by supplying air to the thermally conductive wall.

22. The article of PPE of claim 21, further comprising a thermal-interface material disposed between and contacting the thermally conductive wall and at least one of the battery and the charging circuit.

23. (canceled)

24. The article of PPE of claim 1, further comprising a charging filter disposed upstream of the fan, and wherein the controller is further configured to detect the charging filter.

25-26. (canceled)

27. The article of PPE of claim 24, wherein the controller is further configured to operate the fan during charging of the battery to cool at least one of the battery and the charging circuit only upon detection of the charging filter.

28. The article of PPE of claim 1, wherein the fan is further configured to maintain a temperature of at least one of the battery and the charging circuit below a threshold temperature.

29. (canceled)

30. The article of PPE of claim 1, wherein the controller is further configured to control the fan to indicate partial or full completion of charging of the battery.

31. (canceled)

32. The article of PPE of claim 1, further comprising
a hermetically sealed housing, wherein the battery and the charging circuit are disposed within the hermetically sealed housing; and
a phase-change material disposed within the hermetically sealed housing, and wherein the phase-change material is configured to maintain a temperature of at least one of the battery and the charging circuit below a threshold temperature.

33-34. (canceled)

35. The article of PPE of claim 32, wherein the phase-change material comprises a dielectric liquid, and wherein at least one of the charging circuit and the battery is in contact with the dielectric liquid.

36-37. (canceled)

38. A powered air purifying respirator (PAPR) comprising:
a housing;
a battery disposed within the housing and configured to power one or more components of the PAPR;
a charging circuit disposed within the housing and configured to receive electrical power from a power supply and supply an electric current to the battery;
a controller configured to:
determine a plurality of thresholds of one or more electrical parameters of the battery, the plurality of thresholds having progressively increasing values;
determine the one or more electrical parameters of the battery; and
control the charging circuit to progressively decrease a magnitude of the electric current supplied to the battery when the one or more electrical parameters progressively increase above each threshold from the plurality of thresholds;
a tubing disposed in fluid communication with the housing;
a filter mounted on the housing; and
a fan disposed within the housing downstream of the filter and configured to drive air through the filter to provide safe air to a person via the tubing, wherein the fan is further configured to cool at least one of the battery and the charging circuit, and wherein the controller is communicably coupled to and configured to control the fan.

39. (canceled)

40. The PAPR of claim 38, wherein the controller is further configured to control the charging circuit to maintain the magnitude of the electric current at a substantially constant value when the one or more electrical parameters are between two adjacent thresholds from the plurality of thresholds.

41. The PAPR of claim 38, wherein the plurality of thresholds comprises at least a first threshold, a second threshold greater than the first threshold, and a third threshold greater than the second threshold, and wherein the controller is further configured to control the charging circuit, such that:
the electric current is maintained at a first magnitude when the one or more electrical parameters are between the first threshold and the second threshold; and
the electric current is maintained at a second magnitude that is less than the first magnitude when the one or more electrical parameters are between the second threshold and the third threshold.

42. The PAPR of claim 38, wherein the controller is further configured to determine the plurality of thresholds of the one or more electrical parameters based on one or more of a health of the battery, a temperature of the battery, an impedance of the battery, an age of the battery, and a number of charge cycles of the battery.

43-45. (canceled)

46. The PAPR of claim 45, wherein the battery comprises a plurality of electrochemical cells, and wherein the charging circuit comprises a printed circuit board disposed adjacent to the plurality of electromechanical cells, such that a board passage is defined between the printed circuit board and the electromechanical cells, wherein the fan is configured to direct a flow of air to the board passage.

47-49. (canceled)

50. The PAPR of claim 38, further comprising a thermally conductive wall thermally coupled to at least one of the battery and the charging circuit, and wherein the fan is configured to cool at least one of the battery and the charging circuit by supplying air to the thermally conductive wall.

51. The PAPR of claim 50, further comprising a thermal-interface material disposed between and contacting the thermally conductive wall and at least one of the battery and the charging circuit.

52. (canceled)

53. The PAPR of claim 38, further comprising a charging filter disposed upstream of the fan, and wherein the controller is further configured to detect the charging filter.

54. The PAPR of claim 53, wherein the controller is further configured to detect the charging filter via a radio frequency identification (RFID) communication protocol.

55. The PAPR of claim 53, wherein the controller is further configured to detect the charging filter via a momentary switch or a presence-detection sensor.

56. The PAPR of claim 53, wherein the controller is further configured to operate fan during charging of the battery to cool at least one of the battery and the charging circuit only upon detection of the charging filter.

57. The PAPR of claim 38, wherein the fan is further configured to maintain a temperature of at least one of the battery and the charging circuit below a threshold temperature.

58. (canceled)

59. The PAPR of claim 38, wherein the controller is further configured to control the fan to indicate partial or full completion of charging of the battery.

60. (canceled)

61. The PAPR of claim 38, further comprising
a hermetically sealed housing disposed within the housing, wherein the battery and the charging circuit are disposed within the hermetically sealed housing; and
a phase-change material disposed within the hermetically sealed housing, and wherein the phase-change material is configured to maintain a temperature of at least one of the battery and the charging circuit below a threshold temperature.

62-63. (canceled)

64. The PAPR of claim 61, wherein the phase-change material comprises a dielectric liquid, and wherein at least one of the charging circuit and the battery is in contact with the dielectric liquid.

65. The PAPR of claim 63, wherein the phase-change material directly engages and surrounds the battery, the phase-change material defining an outer surface distal to the battery, wherein the outer surface has a rectangular cross-sectional shape.

66. (canceled)
